(19) United States
(12) Patent Application Publication
(10) Pub. No.: US 2008/0168042 A1
(43) Pub. Date: Jul. 10, 2008

(54) GENERATING SUMMARIES FOR QUERY RESULTS BASED ON FIELD DEFINITIONS

(76) Inventors: Richard D. Dettinger, Rochester, MN (US); Frederick A. Kulack, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/621,301

(22) Filed: Jan. 9, 2007

(51) Int. Cl. G06F 17/30

(52) U.S. Cl. 707/4; 707/E17.07

(57) ABSTRACT

Embodiments of the invention provide techniques for generating summaries for query results based on field definitions. The summaries are generated automatically according to specifications in the field definitions of the fields included in the query results. Each result field may include one or more summaries that are designed to summarize the type of data of the particular field.

### CROSS-REFERENCE TO RELATED APPLICATIONS

This application is related to the following: commonly assigned, co-pending, U.S. Pat. No. 6,996,558, filed Feb. 7, 2006, titled “Application Portability and Extensibility through Database Schema and Query Abstraction;” commonly assigned, co-pending U.S. Pat. No. 7,054,877, filed May 30, 2006, titled “Dealing with Composite Data through Data Model Entities;” and commonly assigned, co-pending application titled “Abstract Query Plan,” Ser. No. 11/005,418, filed Dec. 6, 2004, each of which is incorporated by reference herein in its entirety.

### BACKGROUND OF THE INVENTION

1. Field of the Invention

The invention generally relates to computer database systems. More particularly, the invention relates to techniques for generating summaries for query results based on field definitions.

2. Description of the Related Art

Databases are well known systems for storing, searching, and retrieving information stored in a computer. The most prevalent type of database used today is the relational database, which stores data using a set of tables that may be reorganized and accessed in a number of different ways. Users access information in relational databases using a relational database management system (DBMS).

Each table in a relational database includes a set of one or more columns. Each column typically specifies a name and a data type (e.g., integer, float, string, etc), and may be used to store a common element of data. For example, in a table storing data about patients treated at a hospital, each patient might be referenced using a patient identification number stored in a “patient ID” column. Reading across the rows of such a table would provide data about a particular patient. Tables that share at least one attribute in common are said to be “related.” Further, tables without a common attribute may be related through other tables that do share common attributes. A path between two tables is often referred to as a “join,” and columns from tables related through a join may be combined to from a new table returned as a set of query results.

Queries of a relational database may specify which columns to retrieve data from, how to join the columns together, and conditions (predicates) that must be satisfied for a particular data item to be included in a query result table. Current relational databases require that queries be composed in complex query languages. Today, the most widely used query language is Structured Query Language (SQL). However, other query languages are also used. A SQL query is composed from one or more clauses set off by a keyword. Well-known SQL keywords include the SELECT, WHERE, FROM, HAVING, ORDER BY, and GROUP BY keywords. Composing a proper SQL query requires that a user understand both the structure and content of the relational database as well as the complex syntax of the SQL query language (or other query language). The complexity of constructing an SQL statement, however, generally makes it difficult for average users to compose queries of a relational database.

Because of this complexity, users often turn to database query applications to assist them in composing queries of a database. One technique for managing the complexity of a relational database, and the SQL query language, is to use database abstraction techniques. Commonly assigned U.S. Pat. No. 6,996,558, filed Feb. 7, 2006, (the '075 application) entitled “Application Portability and Extensibility through Database Schema and Query Abstraction,” discloses techniques for constructing a database abstraction model over an underlying physical database.

The '075 application discloses embodiments of a database abstraction model constructed from logical fields that map to data stored in the underlying physical database. Each logical field defines an access method that specifies a location (i.e., a table and column) in the underlying database from which to retrieve data. Users compose an abstract query by selecting logical fields and specifying conditions. The operators available for composing conditions in an abstract query generally include the same operators available in SQL (e.g., comparison operators such as =, >, <, >=, and, <=, and logical operators such as AND, OR, and NOT). Data is retrieved from the physical database by generating a resolved query (e.g., an SQL statement) from the abstract query. Because the database abstraction model is tied to neither the syntax nor the semantics of the physical database, additional capabilities may be provided by the database abstraction model without having to modify the underlying database. Thus, the database abstraction model provides a platform for additional enhancements that allow users to compose meaningful queries easily, without having to disturb existing database installations.

A user interacts with the database abstraction model to compose and execute queries that retrieve data from the underlying physical database. The query results are usually retrieved as a set of data records, the number of which can often be quite large (i.e., thousands of records.) Often, a user will not examine each record individually, but will instead search for patterns or trends in the data. Such analysis usually requires that the data be summarized. For example, a medical researcher may need to determine the age distribution of patients undergoing a particular treatment. The researcher may compose a query to retrieve the set of records for all patients that are undergoing the treatment. Examining each record individually would likely not be very useful, especially if there are a large number of records. Instead, the researcher may, in one instance, create a summary of the records by classifying them into categories (e.g., infant, child, adult, senior,) and then totaling the number of records in each category. Alternatively, the data could be summarized according to other techniques known in the art. The data summary may be presented as text (i.e., numbers in a table or spreadsheet) or as graphics (i.e., pie charts or line graphs.) The summary will enable the researcher to gain an overview of the query results, and make it easier to discern patterns or trends.

Conventionally, creating such summaries typically requires that the query results be processed with specialized query tools, either in database management systems (DBMS) or in separate software packages. However, these tools usually require some training of the user, as well as the time and effort required to import the query results into the tool and to perform the summarization. In many situations, a user may not have the training or time to create a summary by using such tools. Instead, a user may wish to have a summary that is provided automatically.

One approach is to use dashboards, which are applications for automatically generating data summaries. Dashboards are configured to summarize data in a pre-defined manner, and thus typically do not require user training, time, or effort. However, this means that dashboards are static in nature, and always summarize data in the same manner. That is, dashboards do not allow data to be summarized in different ways depending on the particular query results.

Therefore, there is a need in the art for techniques for generating summaries for query results based on field definitions.

### SUMMARY OF THE INVENTION

One embodiment of the invention includes a method of generating summaries for database query results, the method including executing a database query, identifying one or more data summaries specified in the field definitions of the result fields of the query results, and executing the one or more data summaries.

Another embodiment of the invention provides a computer-readable medium storing instructions for generating summaries for database query results, the instructions including executing a database query, identifying one or more data summaries specified in the field definitions of the result fields of the query results, and executing the one or more data summaries.

Another embodiment of the invention provides a system. The system generally includes a physical database, a database abstraction model of the data stored in the physical database, a runtime component, and a query building interface. Generally, the database abstraction model of the system defines a plurality of logical fields that each specifies an access method for accessing data in the physical database, wherein the logical fields include summary specifications that specify summaries that are generated for query results. Generally, the runtime component of the system is configured to receive an abstract query composed from the plurality of logical fields, and in response, and further configured to generate and execute a resolved query of the underlying physical database, thereby retrieving an initial query result, and further configured to generate a summary of the query results according to the summary specified for the logical field. Generally, the query building interface of the system allows the composing of the abstract query from the plurality of logical fields, wherein the interface is configured to display the initial query result to a user, and further configured to generate the request to perform a model entity operation.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary computing and data communications environment, according to one embodiment of the invention.

FIG. 2A illustrates a logical view of the database abstraction model constructed over an underlying physical database, according to one embodiment of the invention.

FIG. 2B illustrates an exemplary abstract query and database abstraction model, according to one embodiment of the invention.

FIG. 3 illustrates a method for generating summaries for query results based on field definitions, according to one embodiment of the invention.

FIGS. 4A-F illustrate an exemplary graphical user interface screen displaying a set of query results and data summaries, according to one embodiment of the invention.

### DETAILED DESCRIPTION OF THE PREFERRED EMBODIMENTS

Embodiments of the invention provide techniques for generating summaries for query results based on field definitions. In general, the summaries are generated according to specifications in the field definitions of the fields included in the query results. Each result field may include one or more summaries that are designed to summarize the type of data of the particular field.

The generated summaries advantageously enable a user to gain an overview of the query results, and to discern patterns or trends in the data. In one embodiment, the summaries are generated without requiring the user to perform any additional steps beyond creating the query, and without requiring the user to undergo specialized training.

In addition, the summaries may be configured to enable the user to easily compare the query results from various aspects of the data. For example, it may be advantageous to a user to compare a summary of the query results to a summary of all records in database.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

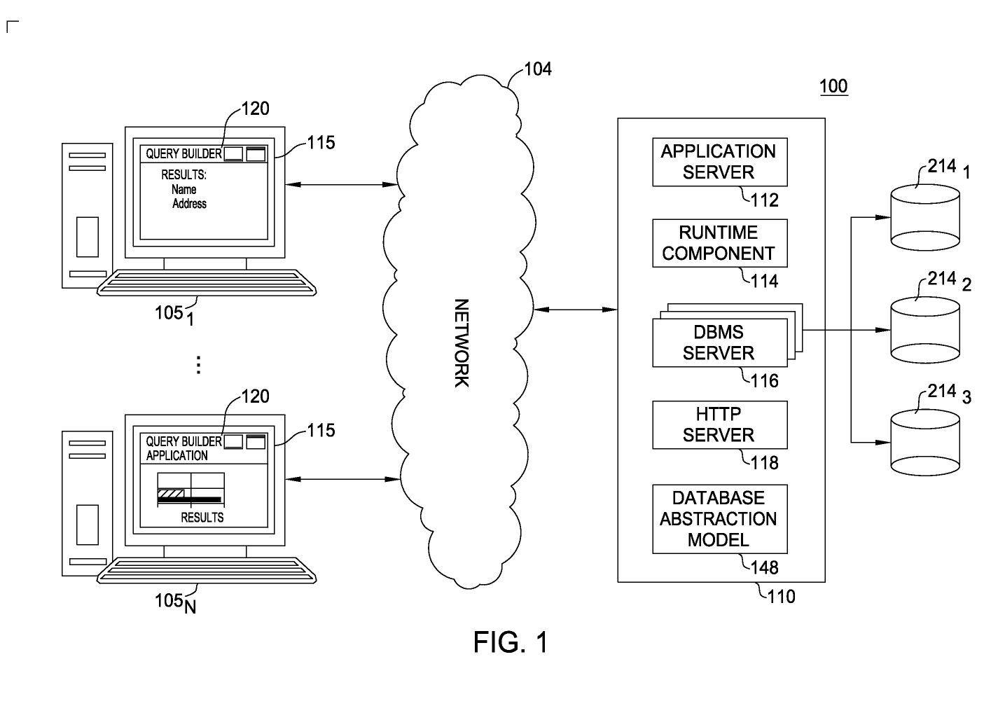

One embodiment of the invention is implemented as a program product for use with a computer system such as, for example, the network environment 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### The Database Abstraction Model: Physical View of the Environment

FIG. 1 illustrates a networked computer system using a client-server configuration. Client computer systems 105_{1-N} include an interface that enables network communications with other systems over network 104. The network 104 may be a local area network where both the client system 105 and server system 110 reside in the same general location, or may be network connections between geographically distributed systems, including network connections over the Internet. Client system 105 generally includes a central processing unit (CPU) connected by a bus to memory and storage (not shown). Each client system 105 is typically running an operating system configured to manage interaction between the computer hardware and the higher-level software applications running on the client system 105 (e.g., a Linux® distribution, a version of the Microsoft Windows® operating system IBM's AIX® or OS/400®, FreeBSD, and the like). (“Linux” is a registered trademark of Linus Torvalds in the United States and other countries.)

The server system 110 may include hardware components similar to those used by the client system 105. Accordingly, the server system 110 generally includes a CPU, a memory, and a storage device, coupled by a bus (not shown). The server system 110 is also running an operating system, (e.g., a Linux® distribution, Microsoft Windows®, IBM's OS/400® or AIX®, FreeBSD, and the like).

The environment 100 illustrated in FIG. 1, however, is merely an example of one computing environment. Embodiments of the present invention may be implemented using other environments, regardless of whether the computer systems are complex multi-user computing systems, such as a cluster of individual computers connected by a high-speed network, single-user workstations, or network appliances lacking non-volatile storage. Further, the software applications illustrated in FIG. 1 and described herein may be implemented using computer software applications executing on existing computer systems, e.g., desktop computers, server computers, laptop computers, tablet computers, and the like. However, the software applications described herein are not limited to any currently existing computing environment or programming language, and may be adapted to take advantage of new computing systems as they become available.

In one embodiment, users interact with the server system 110 using a graphical user interface (GUI) provided by an interface 115. In a particular embodiment, GUI content may comprise HTML documents (i.e., web-pages) rendered on a client computer system 105₁ using web-browser 122. In such an embodiment, the server system 110 includes a Hypertext Transfer Protocol (HTTP) server 118 (e.g., a web server such as the open source Apache web-server program or IBM's Web Sphere® program) configured to respond to HTTP requests from the client system 105 and to transmit HTML documents to client system 105. The web-pages themselves may be static documents stored on server system 110 or generated dynamically using application server 112 interacting with web-server 118 to service HTTP requests. Alternatively, client application 120 may comprise a database front-end, or query application program running on client system 105_{N}. The web-browser 122 and application 120 may be configured to allow a user to compose an abstract query, and to submit the query to the runtime component 114 for processing.

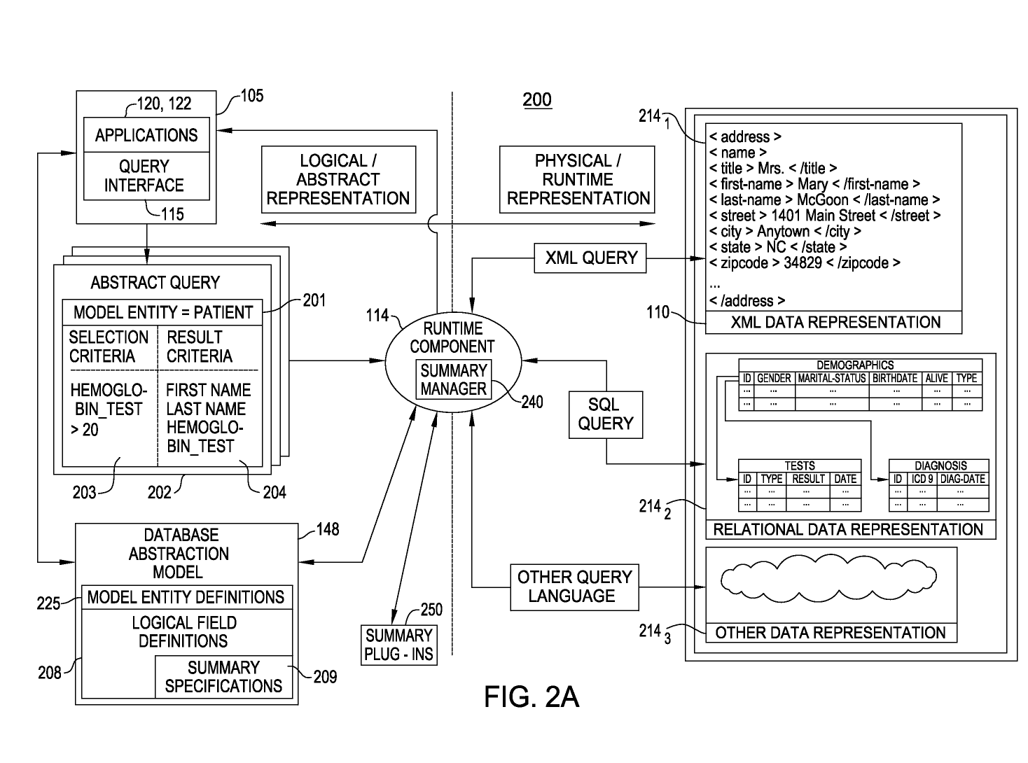

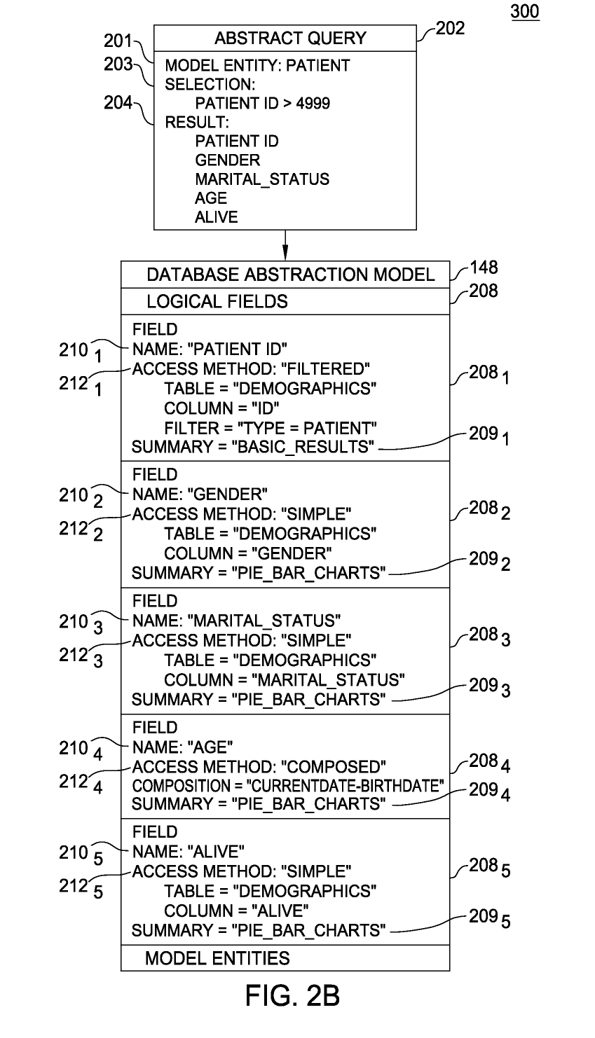

As illustrated in FIG. 1, server system 110 may further include runtime component 114, DBMS server 116, and database abstraction model 148. In one embodiment, these components may be provided using software applications executing on the server system 110. The DBMS server 116 includes a software application configured to manage databases 214₁₋₃. That is, the DBMS server 116 communicates with the underlying physical database system, and manages the physical database environment behind the database abstraction model 148. Users interact with the query interface 115 to compose and submit an abstract query to the runtime component 114 for processing. Typically, users compose an abstract query from the logical fields defined by the database abstraction model 148. Logical fields and access methods are described in greater detail below in reference to FIGS. 2A-2B.

In one embodiment, the runtime component 114 may be configured to receive an abstract query, and in response, to generate a “resolved” or “concrete” query that corresponds to the schema of underlying physical databases 214. For example, the runtime component 114 may be configured to generate one or more SQL queries from an abstract query. The resolved queries generated by the runtime component 114 are supplied to DBMS server 116 for execution. Additionally, the runtime component 114 may be configured to modify the resolved query with additional restrictions or conditions, based on the focus of the abstract query.

### The Database Abstraction Model: Logical View of the Environment

FIG. 2A illustrates a plurality of interrelated components of a database abstraction model, along with relationships between the logical view of data provided by the abstraction model environment (the left side of FIG. 2A), and the underlying physical database mechanisms used to store the data (the right side of FIG. 2A).

In one embodiment, the database abstraction model 148 provides a set of logical field definitions 208 and model entity definitions 225. Users compose an abstract query 202 by specifying selection criteria 203 and result fields 204. An abstract query 202 may identify a selected model entity 201 from the set of model entities 225. The resulting query is generally referred to herein as an “abstract query” because it is composed using logical fields 208 rather than direct references to data structures in the underlying physical databases 214. The model entity 225 may be used to indicate the focus of the abstract query 202 (e.g., a “patient”, a “person”, an “employee”, a “test”, a “facility” etc). Additional examples of model entities 225 are described in commonly assigned, co-pending U.S. Pat. No. 7,054,877, filed May 30, 2006, titled “Dealing with Composite Data through Data Model Entities,” incorporated herein by reference in its entirety.

Illustratively, the abstract query 202 indicates that the abstract query 202 is focused on instances of the “patient” model entity 201. The abstract query 202 further includes selection criteria 203 indicating that data for patients with a “hemoglobin_test>20” should be retrieved in response to processing the abstract query 202. The selection criteria 203 are composed by specifying a condition evaluated against the data values corresponding to a logical field 208 (in this example, the “hemoglobin_test” logical field). The operators in a condition typically include comparison operators such as =, >, <, >=, or, <=, and logical operators such as AND, OR, and NOT. Result fields 204 indicate that data retrieved for abstract query 202 should return data for the “name,” and “hemoglobin_test” logical fields for each instance of the “patients” entity that have data satisfying selection criteria 203 in the underlying physical database.

In one embodiment, users compose an abstract query 202 using the query building interface 115. The interface 115 may be configured to allow users to compose an abstract query 202 from the logical fields 208. The definition for each logical field 208 in the database abstraction model 148 may identify an access method. The access method may be used to map from the logical view of data exposed to a user interacting with the interface 115 to the physical view of data used by the runtime component 114 to retrieve data from the physical databases 214. Thus, the runtime component 114 retrieves data from the physical database 214 by generating a resolved query from the abstract query 202, according to the access methods 208 for the logical fields included in the query. For example, an access method may include a query contribution used in building a resolved query, such as one or more SQL clauses that reference data objects in the underlying physical database 214.

Further, depending on the access method specified for a logical field 208, the runtime component 114 may generate a query of many different underlying storage mechanisms. For example, for a given logical field, the runtime component may be generate an XML query that queries data from database 214₁, an SQL query of relational database 214₂, or other query composed according to another physical storage mechanism using “other” data representation 214₃, or combinations thereof (whether currently known or later developed). Particular types of access methods and embodiments for executing abstract queries are further described in commonly assigned, co-pending, U.S. Pat. No. 6,996,558, filed Feb. 7, 2006, titled “Application Portability and Extensibility through Database Schema and Query Abstraction;” and commonly assigned, co-pending application titled “Abstract Query Plan,” Ser. No. 11/005,418, filed Dec. 6, 2004, both of which are incorporated herein in their entirety.

### Summaries for Query Results Based on Field Definitions

In one embodiment, the logical field definitions 208 may include a set of summary specifications 209. The summary specifications 209 of a logical field 208 specify the summaries that are available for an abstract query 202 which includes the logical field 208 as a result field 204. Thus, if an abstract query 202 is performed which includes a logical field 208 with a given summary specification 209, the specified summary may be generated to summarize the query results for the abstract query 202.

In one embodiment, each logical field 208 may include one or more summary specifications 209. The specified summaries are designed to summarize the type of data of the logical field 208 containing the summary specifications 209. For example, a logical field 208 may store an identifier that classifies each record into one of several discrete groups (e.g., “small”, “medium”, “large”.) Thus, a set of query results that include the logical field 208 may have a summary in the form of a pie chart representing the proportion of query results in each of the discrete groups.

In one embodiment, each summary specified by the summary specifications 209 may be implemented by a summary plug-in 250. The plug-in itself may be an executable code component configured to perform a textual or graphical summarization of the query results. Thus, a plurality of summary plug-ins 250 may be used to provide an additional degree of flexibility in the summarization of database queries. However, summary specifications 209 that operate without reference to a summary plug-in 250 are also contemplated.

FIG. 2B illustrates an exemplary abstract query 202, relative to the database abstraction model 148, according to one embodiment of the invention. In this example, the abstract query 202 includes selection criteria 203 indicating that the query should retrieve instances of the patient model entity 201 with a “Patient ID” value greater than “4999.” The particular information retrieved using abstract query 202 is specified by result fields 204. As shown, the abstract query 202 retrieves the ID, gender, marital status, age, and mortality of the patient.

Once the abstract query 202 is composed, a user may submit it to a runtime component 114 for processing. In one embodiment, the runtime component 114 may be configured to process the abstract query 202 by generating an intermediate representation of the abstract query 202, such as an abstract query plan. An abstract query plan is composed from a combination of abstract elements from the data abstraction model and physical elements relating to the underlying physical database. For example, an abstract query plan may identify which relational tables and columns are referenced by the access methods of the logical fields included in the abstract query. The runtime component may then parse the intermediate representation in order to generate a physical query of the underlying physical database (e.g., an SQL statement(s)). Abstract query plans and query processing are further described in a commonly assigned, co-pending application entitled “Abstract Query Plan,” Ser. No. 11/005,418, filed Dec. 6, 2004, which is incorporated by reference herein in its entirety.

FIG. 2B further illustrates an embodiment of a database abstraction model 148 that includes a plurality of logical field definitions 208₁₋₅ (five shown by way of example). The access methods included in a given logical field definition 208 provide mapping for the logical field to tables and columns in an underlying relational database (e.g., database 214₂ shown in FIG. 2A). As illustrated, each logical field definition 208 identifies a logical field name 210₁₋₅, an associated access method 212₁₋₅, and a summary specification 209₁₋₅. Depending upon the different types of logical fields, any number of access methods may be supported by the database abstraction model 148. FIG. 2B illustrates access methods for simple fields, filtered fields, and composed fields. Each of these three access methods are described below.

A simple access method specifies a direct mapping to a particular entity in the underlying physical database. Logical field definitions 208₂, 208₃, and 208₅ each provide a simple access method, 212₂, 212₃, and 212₅, respectively. For a relational database, the simple access method maps a logical field to a specific database table and column. For example, the simple field access method 212₃ shown in FIG. 2B maps the logical field name 210₃ “Marital status” to a column named “Marital_Status” in a table named “Demographics.”

Logical field definition 208₁ exemplifies a filtered field access method 212₁. Filtered access methods identify an associated physical database and provide rules defining a particular subset of items within the underlying database that should be returned for the filtered field. Consider, for example, a relational table storing medical records for both employees and patients of a medical facility. A logical field for a patient identifier may be defined by using a filter to separate employee records from patient records. For example, a logical field definition 208₁ defines a logical field “Patient ID.” The access method for this filtered field 212₁ maps to the “ID” column of a “Demographics” table and defines a filter “Type=PATIENT.” Only data that satisfies the filter is returned for this logical field. Accordingly, the filtered logical field 208₁ returns a subset of data from a larger set, without the user having to know the specifics of how the data is represented in the underlying physical database, or having to specify the selection criteria as part of the query building process.

Logical field definition 208₄ exemplifies a composed access method 212₄. Composed access methods generate a return value by retrieving data from the underlying physical database and performing operations on the data. In this way, information that does not directly exist in the underlying data representation may be computed and provided to a requesting entity. For example, logical field access method 212₄ illustrates a composed access method that defines the logical field “Age” 208₄ as composed from the current system date (“Currentdate”) and a field named “Birthdate.” The field “Birthdate” is a column in a demographics table of relational database 214₂. In this example, data for the logical field “Age” 208₄ is computed by retrieving data from the underlying database using the field “Birthdate,” and subtracting the birth date value from a current date value to calculate an age value returned for the logical field 208₄.

By way of example, the logical field definitions 208 shown in FIG. 2B are representative of logical fields mapped to data represented in the relational data representation 214₂. However, other instances of the data repository abstraction component 148 or, other logical field definitions, may map to other physical data representations (e.g., databases 214₁ or 214₃ illustrated in FIG. 2A). Further, in one embodiment, the database abstraction model 148 is stored on computer system 110 using an XML document that describes the model entities, logical fields, access methods, and additional metadata that, collectively, define the database abstraction model 148 for a particular physical database system. Other storage mechanisms or markup languages, however, are also contemplated.

As shown in FIG. 2B, each logical field definition 208 includes a summary specification 209. However, it is also contemplated that each logical field definition 208 could include multiple summary specifications 209, or alternatively could not include any summary specifications 209. Illustratively, logical field definition 208₁ includes a summary specification 209₁ which specifies a “Basic_Results” summary. Further, logical field definitions 208₂₋₅ include summary specifications 209₂₋₅, which all specify a “Pie_Bar_Charts” summary. In one embodiment, the summary plug-ins 250 may be executable classes, module programs or routines configured to generate the summaries specified in the summary specifications 209. When an abstract query 202 is performed, the summary plug-ins 250 are called to implement any summary specifications 209 specified in the logical field definitions 208 of the result fields 204.

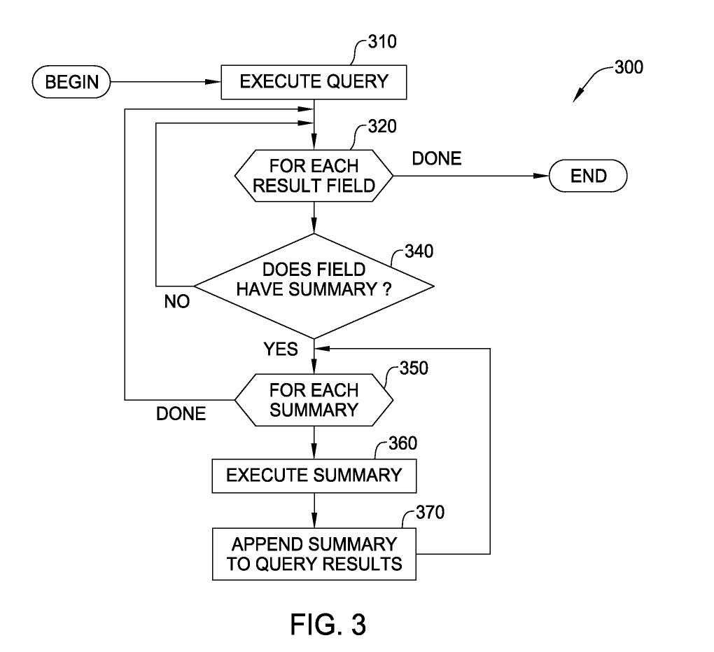

FIG. 3 illustrates a method 300 for generating summaries for query results based on field definitions, according to one embodiment of the invention. The method 300 begins at step 310, where a query (e.g., abstract query 202) is executed. At step 320, the method 300 enters a loop (defined by steps 320, 340, and 350) for processing each result field present in the abstract query, thereby evaluating all query results. At step 340, a determination is made of whether a result field includes a summary specification. That is, for each result field the respective logical field definition is accessed to determine whether the logical field definition contains a summary specification(s). If not, the result field is skipped. Otherwise, the method 300 continues to step 350. At step 350, the method 300 enters a loop (defined by steps 350, 360, and 370) for processing each summary specification defined in a respective logical field definition for a given result field. At step 360, a summary is generated on the basis of the summary specification. It is contemplated that a summary specification may include conditions that must be met in order to generate the summary. For example, a given summary specification may require that the query results include more than a minimum number of records before the summary is generated. In another example, a query of a medical database may include a “Terminal Diagnosis” field, containing the diagnosis codes for the query results. A summary specification included in the logical field definition for the “Terminal Diagnosis” field may have a condition that a field storing the patient age at diagnosis is also part of the query. If so, a summary of the average life expectancy of the patients in the query results may be generated. Otherwise, the summary is not generated. At step 370, the generated summary is appended to the query results. Once all summaries for a given result field are completed, the method 300 returns to step 320 in order to evaluate the next result field. Once all result fields have been completed, the method 300 ends.

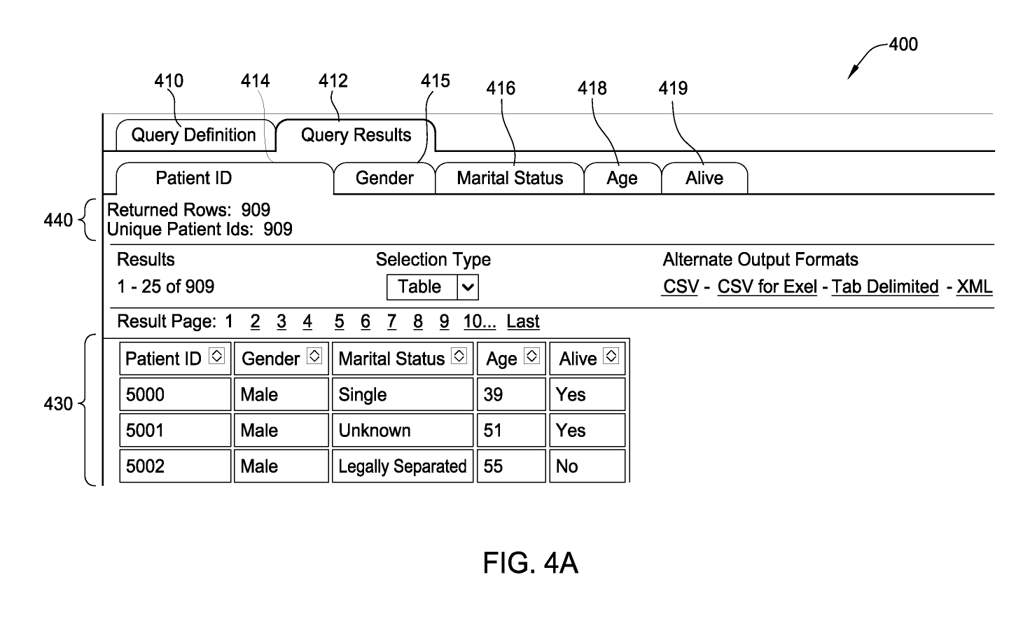

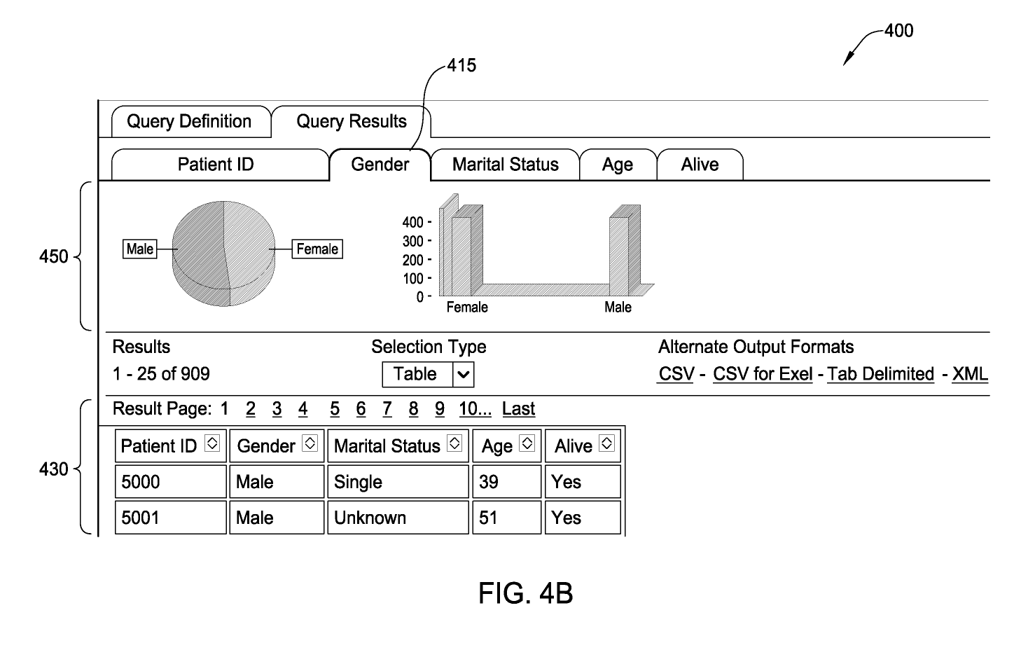

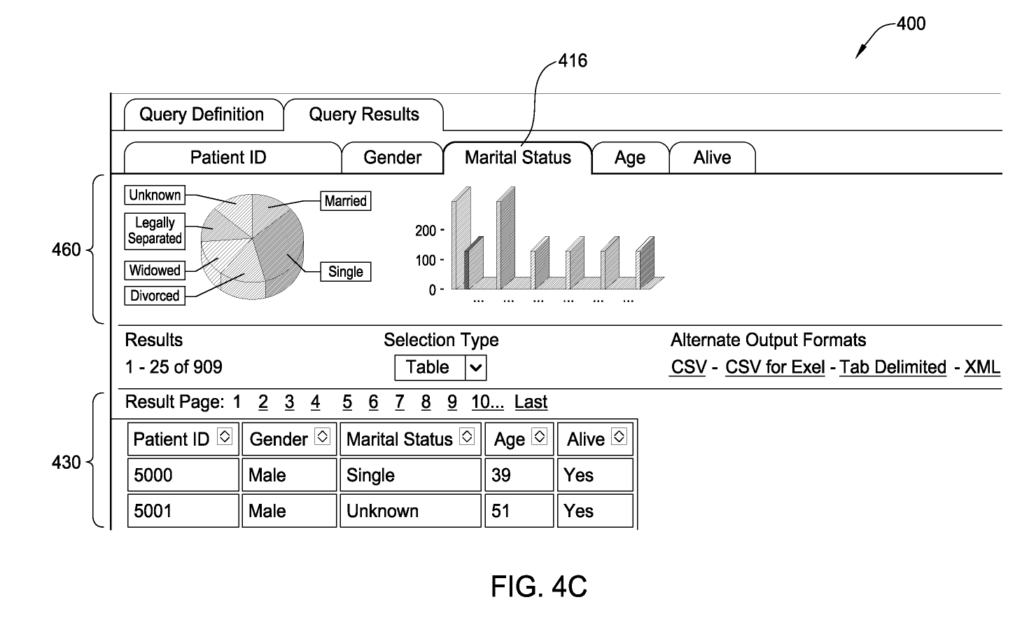

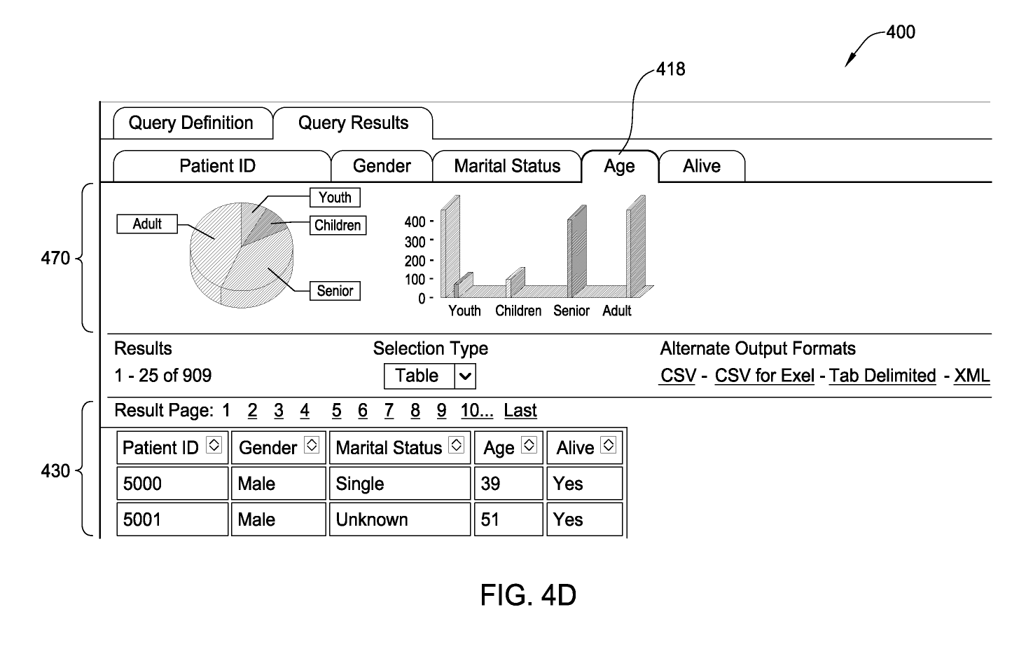

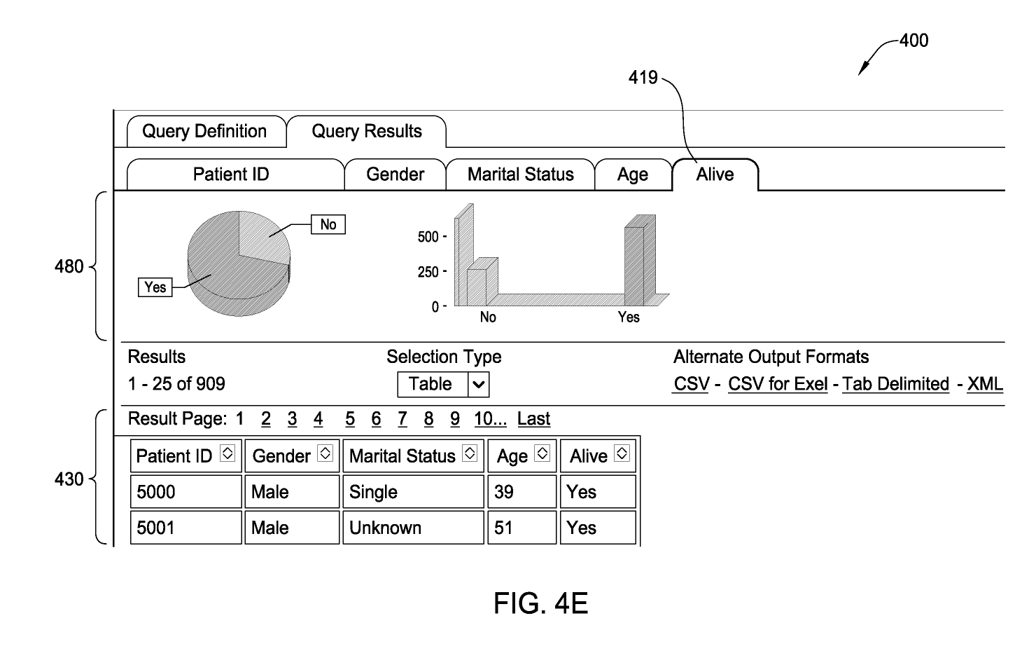

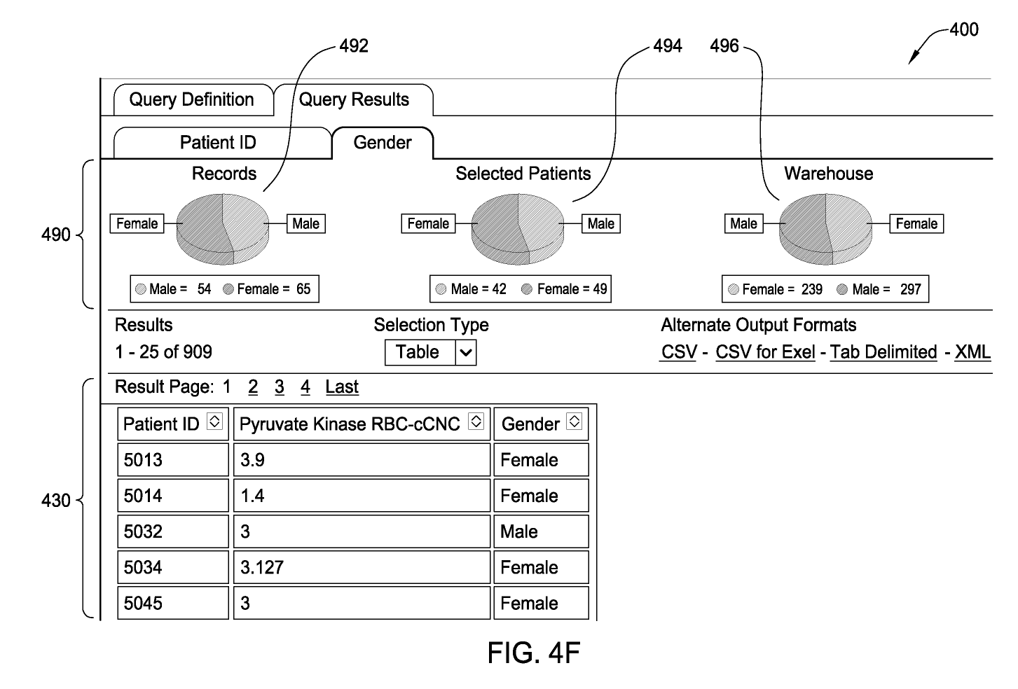

FIGS. 4A-F illustrate an exemplary graphical user interface screen 400 displaying a set of query results and data summaries, according to one embodiment of the invention. Of course, the examples shown in FIGS. 4A-F are for illustrative purposes only, and in no way limits the scope of the invention. The exemplary screen 400 illustrated in FIGS. 4A-E corresponds to the database abstraction model 148 of FIG. 2B, and is generated according to the method 300 of FIG. 3. The screen 400 is a graphical user interface (GUI) that presents the user with multiple selectable views that can be selected by a labeled tab. Hereafter, the selectable views are referred to as “screen tabs” or “tabs.”

FIG. 4A illustrates screen 400, which includes a screen tab for query definition 410 and a screen tab for query results 412. The query definition tab 410 (contents not shown) enables the user to define an abstract query 202 by specifying a model entity 201, selection criteria 203, and result fields 204. The query results tab 412 displays the query results of the abstract query 202 defined in the query definition tab 410. Further, the query results tab 412 includes tabs 414, 415, 416, 418, 419 for each of the result fields 204 of the abstract query 202.

As shown, the “Patient ID” tab 414 includes a summary 440 and a set of query results 430. Illustratively, the query results 430 include a column for each result field 204 of the abstract query 202. The summary 440 includes text descriptions of the number of returned rows and the number of unique patient IDs for the query results 430. As described, a summary is generated when that summary is specified for a result field. Referring back to FIG. 2B, the logical field definitions 208 of the result fields 204 are illustrated, including the summary specifications 209. Illustratively, the logical field definition 208, for the result field “Patient ID” includes a summary specification of “Basic_Results” 209₁. Thus, the summary 440 is of the summary type “Basic_Results.” In one embodiment, the “Basic_Results” summary may be generated by a summary plug-in 250 that is configured to calculate the number of returned rows and number of unique patient IDs, and to present the numbers in a text summary 440.

FIG. 4B illustrates the “Gender” tab 415 of the screen 400, according to one embodiment of the invention. The tab 415 includes the query results 430 and a summary 450. The summary 450 is composed of a pie chart and a bar chart, with each chart providing a graphic representation of the proportion of male and female patients in the query results 430. As shown in FIG. 2B, the logical field definition 208₂ for result field “Gender” includes a specification of summary “Pie_Bar_Chart” 209₂. Thus, the summary 450 is generated (e.g., by an appropriate plug-in) according to the summary specification 209₂ included in the field definition 208₂.

FIG. 4C illustrates the “Marital Status” tab 416 of the screen 400, according to one embodiment of the invention. The tab 416 includes the query results 430 and a summary 460. Similarly to the summary 450 of the “Gender” tab 415, the summary 460 of the “Marital Status” tab 416 is composed of a pie chart and a bar chart. In this case, each chart provides a graphic representation of the proportion of patients in the query results 430 in the marital status categories of married, single, divorced, widowed, legally separated, or unknown. The summary 460 is generated (e.g., by an appropriate plug-in) according to the specification of the summary type “Pie_Bar_Chart” 209₃ in the logical field definition 208₃ for result field “Marital Status.”

In another example, FIG. 4D illustrates the summary 470 of the “Age” tab 418, which is composed of a pie chart and a bar chart. In this case, each chart provides a graphic representation of the proportion of patients in the query results 430 in the age categories of adult, youth, children, or senior. The summary 470 is generated (e.g., by an appropriate plug-in) according to the specification of the summary type “Pie_Bar_Chart” 209₄ in the logical field definition 2084 for result field “Age.” Likewise, FIG. 4E illustrates the summary 480 of the “Alive” tab 419, which is also composed of a pie chart and a bar chart. In this case, each chart provides a graphic representation of the proportion of patients in the query results 430 that are either alive or dead. The summary 480 is generated according to the specification of the summary type “Pie_Bar_Chart” 209₅ in the logical field definition 2085 for result field “Alive.”

By way of example, the summaries 440, 450, 460, 470, 480 illustrated in FIGS. 4A-E are representative of text, pie chart, or bar chart summaries. However, it is contemplated that other types of summaries could be used.

### Multiple Summaries for Query Results Grouped by Different Fields

In some situations, the records in a database may be structured so they could be grouped by more than one field. If so, a set of query results from the database could be summarized differently, depending on the fields that are grouped in generating the summary.

In one embodiment of the invention, each summary specification 209 may result in multiple summaries, with each summary representing a different set of grouped fields. For example, a hospital patient database may include a table storing records of results of diagnostic tests. Such a table would likely contain multiple records for any patients who have had multiple diagnostic tests. Thus, the query results for a query performed in this exemplary database could be summarized either in terms of the number of unique database records or in terms of the number of unique patients, with each approach resulting in different totals. In one embodiment, a single summary specification 209 could result in both types of summaries being generated.

Further, it is contemplated that it may be advantageous to compare a summary of query results to a summary of all records stored in database. For example, a medical researcher may perform a query in a patient database for those patients that have been diagnosed with a specific condition, and may separate the results by gender. The researcher may wish to compare a summary of the query results to a baseline summary of all patients in the database, including those who have not been diagnosed with the condition. This type of baseline comparison can aid in determining whether the query results are skewed by a bias in the underlying data. That is, if the database records are disproportionately of male patients, the query results may not accurately reveal any gender-related patterns in the occurrence of the condition.

FIG. 4F illustrates the query results 430 and a set of multiple summaries 490, according to one embodiment of the invention. The summaries 490 include three pie charts 492, 494, 496. The first pie chart 492 is labeled “Records,” and provides a graphic representation of the proportion of patient records in the query results 430 by gender. As shown, the “Records” pie chart 492 includes 54 male records and 65 female records. The second pie chart 494 is labeled “Selected Patients,” and provides a graphic representation of the proportion of unique patients in the query results 430 by gender. As shown, the “Selected Patients” pie chart 494 includes 42 male patients and 49 female patients. Importantly, the number of records in the “Records” pie chart 492 is larger than the number of unique patients in the “Selected Patients” pie chart 494, even though both are filtered by the same query conditions. In this example, some patients have had more than one diagnostic test, and thus have multiple records in the database. The disparity in numbers is due to the different fields grouped in the two summaries.

In one embodiment, the summaries 490 also include a third pie chart 496 labeled “Warehouse.” As shown, the “Warehouse” pie chart 496 includes 239 female records and 297 male records. In this example, the “Warehouse” pie chart 496 represents the total records of a patient database, including those records that do not meet the current query conditions. It is contemplated that presenting a user with summaries of various aspects of the data (e.g., pie charts 492, 494, 496 of FIG. 4F) may advantageously enable the user to quickly compare and evaluate the query results.

By way of example, the summaries 490 illustrated in FIG. 4F are representative of pie chart summaries. However, it is contemplated that other types of summaries could be used.

### CONCLUSION

As described, embodiments of the invention provide techniques for generating summaries for query results based on field definitions. In one embodiment, summaries are generated automatically according to specifications in the field definitions of the fields included in the query results. In one embodiment, each result field may include one or more summaries that are designed to summarize the type of data of the particular field.

Thus, the generated summaries advantageously enable a user to gain an overview of the query results. Further, the generated summaries make it easier for the user to discern patterns or trends in the data. Finally, the summaries may be generated by grouping different fields of the data, thus facilitating the evaluation of the query results.

While the foregoing is directed to embodiments of the present invention, other and further embodiments of the invention may be devised without departing from the basic scope thereof, and the scope thereof is determined by the claims that follow.

What is claimed is:

1. A method of generating summaries for query search results, comprising:
receiving the query search results for a query executed against a database, wherein the search results include result fields and corresponding values for the result fields and wherein the result fields have respective field definitions that define attributes of the respective result fields and wherein at least one of the field definitions includes a data summary specification;
identifying one or more data summary specifications defined in the respective field definitions of the result fields of the query search results; and
generating a summary for each of the identified one or more data summary specifications.

2. The method of claim 1, wherein the field definitions are included in a database abstraction model, and wherein each field definition specifies an access method for accessing data in the database corresponding to the field definition, and wherein the executed query is a transformed instance of an abstract query composed on the basis of the database abstraction model and wherein the abstract query includes the result fields.

3. The method of claim 2, wherein the data abstraction model further defines a plurality of focus entities, wherein a user specifies a focus for the abstract query by selecting a focus entity from the plurality of focus entities.

4. The method of claim 1, further comprising presenting the generated summaries in a graphical user interface with the search results.

5. The method of claim 4, wherein the presentation of the search results is performed in one or more tabbed screens of the graphical user interface, wherein each tabbed screen presents one or more of the generated summaries for a given result field.

6. The method of claim 1, wherein at least one of the field definitions includes at least two data summary specifications, wherein each data summary specification causes the data to be summarized differently.

7. The method of claim 1, wherein generating the summary for a given data summary specification comprises invoking an executable plug-in configured to generate the respective summary, wherein the plug-in is invoked using a reference to the plug-in in the given data summary specification.

8. The method of claim 1, wherein generating the summary for each of the identified one or more data summary specifications is performed only upon determining that conditions specified by the identified one or more data summary specifications are satisfied.

9. A computer readable medium containing a program which, when executed, performs an operation of generating summaries for query search results, the operation comprising:
receiving search results for a query executed against a database, wherein the search results include result fields and corresponding values for the result fields and wherein the result fields have respective field definitions that define attributes of the respective result fields and wherein at least one of the field definitions includes a data summary specification;
identifying one or more data summary specifications defined in the respective field definitions of the result fields of the query results; and
generating a summary for each of the identified one or more data summary specifications.

10. The computer readable medium of claim 9, wherein the field definitions are included in a database abstraction model, and wherein each field definition specifies an access method for accessing data in the database corresponding to the field definition, and wherein the executed query is a transformed instance of an abstract query composed on the basis of the database abstraction model and wherein the abstract query includes the result fields.

11. The computer readable medium of claim 10, wherein the data abstraction model further defines a plurality of focus entities, wherein a user specifies a focus for the abstract query by selecting a focus entity from the plurality of focus entities.

12. The computer readable medium of claim 9, further comprising presenting the generated summaries in a graphical user interface with the search results.

13. The computer readable medium of claim 12, wherein the presentation of the search results is performed in one or more tabbed screens of the graphical user interface, wherein each tabbed screen presents one or more of the generated summaries for a given result field.

14. The computer readable medium of claim 9, wherein at least one of the field definitions includes at least two data summary specifications, wherein each data summary specification causes the data to be summarized differently.

15. The computer readable medium of claim 9, wherein generating the summary for a given data summary specification comprises invoking an executable plug-in configured to generate the respective summary, wherein the plug-in is invoked using a reference to the plug-in in the given data summary specification.

16. A system, comprising:
a database abstraction model of data stored in a physical database that defines a plurality of logical fields that each specify an access method for accessing data in the physical database, wherein one or more of the logical fields include data summary specifications applied to generate summaries for query results that include the respective logical field; and
a runtime component configured to receive an abstract query composed from the plurality of logical fields, and further configured to generate a resolved query corresponding to a schema of the underlying physical database, and further configured, upon receiving any query results, to generate a summary for one or more result fields of the abstract query according to the respective data summary specifications of the result fields.

17. The system of claim 16, further comprising a query building interface for composing the abstract query from the plurality of logical fields, wherein the interface is configured to display an initial query result to a user, and further configured to display the generated summaries.

18. The system of claim 17, wherein the query building interface includes one or more tabbed screens, wherein each tabbed screen presents one or more of the generated summaries for a given result field.

19. The system of claim 16, wherein the runtime component causes a given data summary specification to be generated by invoking an executable plug-in configured to generate the respective summary, wherein the plug-in is invoked using a reference to the plug-in in the given data summary specification.

20. The system of claim 16, wherein at least one of the logical fields includes at least two data summary specifications, wherein each data summary specification causes the data to be summarized differently.

21. A system, comprising:
a database abstraction model of data stored in a physical database that defines a plurality of logical fields that each specify an access method for accessing data in the physical database, wherein one or more of the logical fields include data summary specifications applied to generate summaries for query results that include the respective logical field.

22. The system of claim 21, wherein generating the summary for a given data summary specification comprises invoking an executable plug-in configured to generate the respective summary, wherein the plug-in is invoked using a reference to the plug-in in the given data summary specification.

23. The system of claim 21, wherein at least one of the logical fields includes at least two data summary specifications, wherein each data summary specification causes the data to be summarized differently.
